(19) United States
(12) Patent Application Publication
(10) Pub. No.: US 2024/0280971 A1
(43) Pub. Date: Aug. 22, 2024

(54) NC PROGRAM CREATION

(71) Applicant: DMG MORI CO., LTD., Nara (JP)

(72) Inventors: Minoru TANEMOTO, Nara (JP); Naofumi Shimoda, Nara (JP); Yorihito Koda, Nara (JP)

(73) Assignee: DMG MORI CO., LTD., Nara (JP)

(21) Appl. No.: 18/644,933

(22) Filed: Apr. 24, 2024

Related U.S. Application Data
(63) Continuation of application No. PCT/JP2023/038158, filed on Oct. 23, 2023.

(30) Foreign Application Priority Data
Oct. 24, 2022 (JP) 2022-169672
Oct. 17, 2023 (JP) 2023-178820

(51) Int. Cl. G05B 19/416; G05B 19/4155

(52) U.S. Cl. CPC G05B 19/4166; G05B 19/4155

(57) ABSTRACT

A method of creating an NC program for threading includes: a first step of setting a position in the NC program at which a G code or an M code is to be inserted; a second step of making a setting for applying a vibration component in a thread radial direction to a tool movement path; and a third step of, based on an instruction for reflecting the setting made in the second step in the NC program, inserting at the position in the NC program the G code or the M code for applying the vibration component in the thread radial direction, thereby creating the NC program for threading.

### TECHNICAL FIELD

The present invention relates to an NC program creation method, an NC program creation apparatus, and a machine tool including the NC program creation apparatus.

### BACKGROUND ART

A turning machine tool typically machines a workpiece into a preset shape by rotating a cutting tool and the workpiece relative to each other along the circumferential direction of the workpiece and feeding the cutting tool and the workpiece relative to each other along the rotation axis of the workpiece. Such machining may generate long continuous chips. Long continuous chips are likely to remain in the machining chamber; therefore, it is necessary to regularly clean up such chips. Consequently, the time required for the machining of the workpiece is increased. Further, long chips remaining in the machining chamber may damage the workpiece or other parts.

Accordingly, the machine tool described in Patent Literature 1 is configured to break chips by causing a control unit to execute vibration cutting control during turning. In this vibration cutting control, the cutting tool and the workpiece are driven forward and backward relative to each other along the feeding direction (the rotation axis direction) during turning and the portion to be cut in the forward driving and the portion to be cut in the backward driving overlap, so that chips are broken.

### CITATION LIST

### Patent Literature

Patent Literature 1: U.S. patent Ser. No. 10/610,993 (Japanese Patent No. 6914840)

### SUMMARY OF INVENTION

### Technical Problem

There are various kinds of turning that can be performed in a machine tool, for instance, outer diameter machining, inner diameter machining, drilling, taper copying, grooving, end face machining, and threading. However, adding a vibration-related code into a program (e.g., an NC program) for performing these kinds of machining is difficult for those not skilled in machine tool program creation.

Accordingly, the present invention provides an NC program creation method, an NC program creation apparatus, a machine tool including the NC program creation apparatus, etc.

### Solution to Problem

Accordingly, the present invention provides an NC program creation method, an NC program creation apparatus, an NC program creation program, a display controller, a machine tool, etc.

### Advantageous Effects of Invention

The present invention enables even an operator not skilled in machine tool program creation to easily create a program.

### BRIEF DESCRIPTION OF DRAWINGS

FIG. 1 is an illustrative schematic diagram of an exemplary structure of a machine tool;

FIG. 2 is a block diagram showing a configuration of the machine tool;

FIG. 3 is an exemplary graph showing a movement trajectory of a machining point of a tool with respect to position change on a Z-axis;

FIG. 4 shows an example of an input screen to be displayed on an operation panel of the machine tool;

FIG. 5A shows an example of an NC program created by a programming unit;

FIG. 5B shows another example of the NC program created by the programming unit;

FIG. 6A shows an example of a graph screen to be displayed on the operation panel of the machine tool in Modification 1;

FIG. 6B shows another example of the graph screen to be displayed on the operation panel of the machine tool in Modification 1;

FIG. 7 shows an example of a guidance screen to be displayed on the operation panel of the machine tool in Modification 2;

FIG. 8 is a block diagram showing a configuration of the machine tool and a peripheral device of the machine tool;

FIG. 9 shows an example of a screen displayed on a display unit;

FIG. 10 shows an example of cutting paths for threading;

FIG. 11 is an illustrative diagram showing a principal configuration of a motion mechanism system of a machine tool according to a reference mode of the present invention;

FIG. 12 is a block diagram showing a principal configuration of a control system of the machine tool according to the reference mode;

FIG. 13 is an illustrative diagram showing an NC program for performing threading in the reference mode;

FIG. 14 is an illustrative diagram showing vibration conditions in threading in a first mode of the present invention;

FIG. 15 is an illustrative diagram showing tool paths as viewed in a radial direction in the threading in the first mode;

FIG. 16 is an illustrative diagram showing tool paths as viewed in an axial direction in the threading in the first mode;

FIG. 17 is an illustrative diagram showing vibration conditions in threading in a second mode of the present invention;

FIG. 18 is an illustrative diagram showing tool paths as viewed in a radial direction in the threading in the second mode;

FIG. 19 is an illustrative diagram showing tool paths as viewed in an axial direction in the threading in the second mode;

FIG. 20 is an illustrative diagram showing vibration conditions in threading in a third mode of the present invention;

FIG. 21 is an illustrative diagram showing tool paths as viewed in a radial direction in the threading in the third mode; and

FIG. 22 is an illustrative diagram showing tool paths as viewed in an axial direction in the threading in the third mode.

### DESCRIPTION OF EMBODIMENTS

### (Machine Tool)

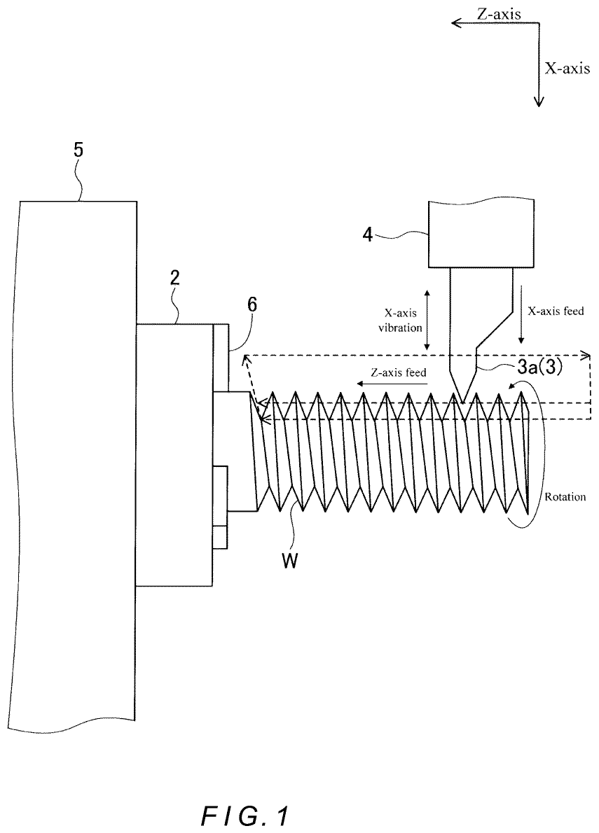

FIG. 1 is a schematic diagram showing principal elements of a machine tool 1. The machine tool 1 is an NC lathe that performs turning on a workpiece W by bringing a cutting tool 3 into contact with the workpiece W while rotating the workpiece W. Examples of the turning include outer diameter machining, inner diameter machining, drilling, taper copying, grooving, end face machining, and threading. FIG. 1 shows a state where threading is being performed. When performing threading, the machine tool 1 moves the workpiece W and the cutting tool 3 relative to each other on a Z-axis and vibrates the cutting tool 3 in the radial direction of the workpiece W in accordance with a program code.

In the following description, the axis of rotation of the workpiece W is designated as the Z-axis, a vertical direction perpendicular to the Z-axis is designated as an X-axis, and a direction perpendicular to both the X-axis and the Z-axis (a direction perpendicular to the paper surface of FIG. 1) is designated as a Y-axis. In FIG. 1, the radial direction of the workpiece W is parallel to the X-axis.

In applying vibration in threading, it is preferred, but not limited to, that the tool 3a or the workpiece is vibrated parallel to the X-axis. The vibration may take place in a direction parallel to the Y-axis or may take place in a direction having an X-axis component and a Y-axis component. Further, although it is preferred that the vibration is applied in the threading such that the vibration takes place in the radial direction of the workpiece W, the vibration can take place in any direction including a vibration component in the radial direction of the workpiece W. For example, in FIG. 1, the vibration may take place in a direction having an X-axis component and a Z-axis component.

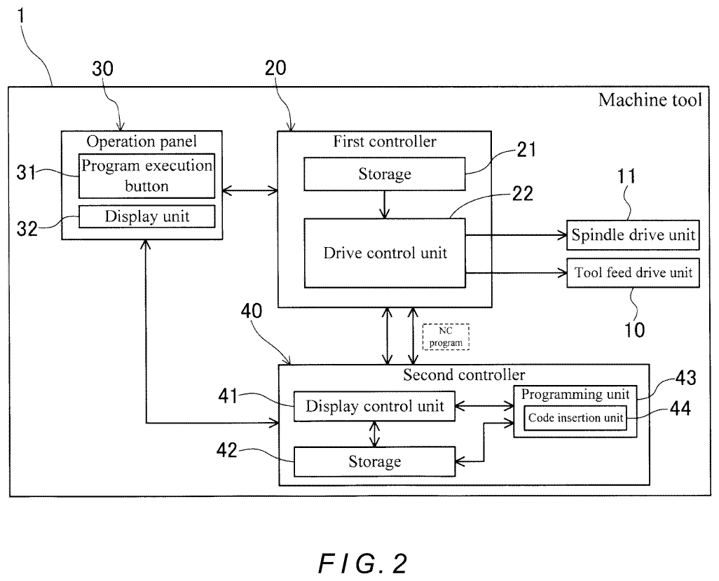

The machine tool 1 has a spindle 2 (an example of the workpiece holding unit), a headstock 5, the cutting tool 3, and a tool holding unit 4 (e.g., a tool rest or a tool spindle). The spindle 2 has a chuck mechanism 6 on the distal end thereof. The headstock 5 holds the spindle 2 in a rotatable manner. The tool holding unit 4 holds the cutting tool 3 such that the cutting tool 3 is movable in the X-axis, the Y-axis, and the Z-axis. The headstock 5 is fixed on a bed of the machine tool 1 and has a spindle drive unit 11 (FIG. 2) incorporated therein that rotationally drives the spindle 2. The spindle drive unit 11 (FIG. 2) is composed of, for example, a servo motor. The spindle drive unit 11 functions as a rotation drive unit that rotates the cutting tool 3 and the workpiece W relative to each other along the circumferential direction of the workpiece W.

The cutting tool 3 illustrated in FIG. 1 is a general-purpose tool 3a for a lathe. FIG. 1 shows an example in which the tool 3a is held by the tool holding unit 4.

The tool holding unit 4 is driven in the axis directions by a tool feed drive unit 10 (FIG. 2). The tool feed drive unit 10 includes an X-axis feed mechanism, a Y-axis feed mechanism, and a Z-axis feed mechanism that respectively perform feeding on the X-axis, the Y-axis, and the Z-axis. Each feed mechanism is composed of, for example, a combination of a ball screw and a servo motor.

### (Configuration of Machine Tool and Peripheral Devices)

As illustrated in FIG. 2, the machine tool 1 includes a first controller 20 that controls the movement of the tool 3a and workpiece W. The first controller 20 has a storage 21 and a drive control unit 22. The storage 21 stores a program for executing (interpreting) an NC program and transmitting drive signals to the spindle drive unit 11 and the tool feed drive unit 10. The drive control unit 22 has an OS etc. for causing the program to function. In the machine tool 1, the spindle drive unit 11 and the tool feed drive unit 10 move the workpiece W and the tool 3a upon receipt of signals from the first controller 20.

The drive control unit 22 of the first controller 20 executes (analyzes) the NC program stored in the storage 21 and thereby creates operation commands based on operation codes in the NC program; thus, the drive control unit 22 drives the spindle drive unit 11 and the tool feed drive unit 10 in accordance with the operation commands.

The first controller 20 implements these drive controlling function and storing function through processing in computing means such as a CPU or an LSI.

The machine tool 1 further includes a second controller 40 that controls display on a display unit 32 of an operation panel. The second controller 40 has a storage 42, a display control unit 41, and a programming unit 43. The storage 42 stores a program for controlling screen display on the operation panel 30. The display control unit 41 has an OS etc. for causing the program to function. The programming unit 43 creates an NC program.

The storage 42 of the second controller 40 stores a program for assisting NC program creation, a program for displaying an input screen 35 for the NC program creation assistance, etc. The display control unit 41 of the second controller 40 has an OS for causing these programs to function. The display control unit 41 causes these programs to function so that the NC program creation assistance is realized on the displayed screen. The programming unit 43 creates an NC program based on information on conditions and the like set through the NC program creation assistance screen. The programming unit 43 may have a function to directly write an NC code such as a G code or an M code to directly create or edit an NC program or a function to insert a G code or an M code at a line or block in an NC program (code insertion unit 44).

The second controller 40 implements these storing function, display controlling function, and programming function through processing in computing means such as a CPU or an LSI that is different from the computing means in the first controller 20.

The operation panel 30 has a program execution button 31 and a display unit 32 (e.g., a touch panel) thereon. The display unit 32 displays thereon screens for displaying a program, machine tool information (e.g., coordinates), etc. On the operation panel, an operator can carry out operations, such as making various machining-related settings and creating an NC program, while checking the display on the display unit 32.

Once the program execution button 31 on the operation panel 30 of the machine tool 1 is pressed, the drive control unit 22 starts execution of the NC program. The drive control unit 22 reads the NC program stored in the storage 21. The drive control unit 22 controls the spindle drive unit 11 and the tool feed drive unit 10 in accordance with the NC program, thereby executing the machining.

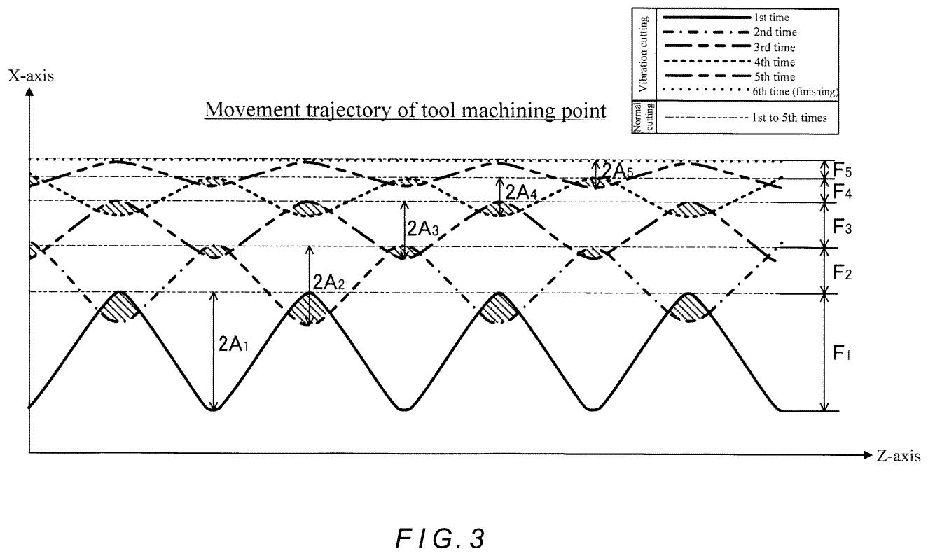

In threading, the spindle 2 holding the workpiece W is rotated about the Z-axis by the spindle drive unit 11. The depth of cut of the tool 3a on the X-axis is set to a predetermined value by the position of the tool holding unit 4 on the X-axis being specified on the NC program by the tool feed drive unit 10. In this state, the tool holding unit 4 is driven and fed in the Z-axis direction by the tool feed drive unit 10 so that the tool 3a is relatively moved on a line parallel to the axis of rotation of the workpiece W. In threading, this relative movement of the tool 3a is performed a plurality of times. The movement trajectories of the machining point of the tool 3a are each indicated by a dotted line in FIG. 1. As shown, the operation of cutting the thread surface is performed a plurality of times with non-identical and different cutting paths. That is to say, the program is not created such that the movement trajectories of the machining point follow the same cutting path. The dotted lines in FIG. 1 indicate straight movement trajectories of the machining point of the tool 3a in conventional threading. In this embodiment, a vibration component is added to such a movement trajectory. For example, the movement trajectory in the second vibration cutting in FIG. 3 is generated by applying vibration to a straight movement trajectory as indicated by the dotted line in FIG. 1.

In the conventional threading, as described above, since the portion circumferentially along the dotted line in FIG. 1 is to be cut in one cutting operation, the depth of cut of the tool 3a on the X-axis (in the workpiece radial direction) with respect to the workpiece W is constant during one cutting operation (throughout the portion to be cut).

In this embodiment, in contrast, an NC program for threading is created to include a code changing the depth of cut of the tool 3a in the X-axis direction (radial direction) during one cutting operation. In particular, it is preferable that the NC program includes a G code or an M code which periodically changes the depth of cut as in the first vibration cutting operation in FIG. 3.

### (NC Program)

Creation of an NC program including a vibration-related code is outlined here. Specifically, creation of an NC program for threading is described. Note that the following description is not limited to threading.

FIG. 3 is a graph showing machining paths in threading performed in the machine tool 1 in accordance with an NC program created according to this embodiment. The vertical axis of the graph represents the amount of movement of the machining point of the tool 3a on the X-axis (the depth of cut in the workpiece radial direction). The horizontal axis of the graph represents the amount of movement of the machining point of the tool 3a (the position of the machining point of the tool 3a) on the Z-axis.

As shown in the graph, the drive control unit 22 in this embodiment executes a machining process six times with the machining paths by controlling the relative movement of the workpiece W and tool 3a in accordance with the NC program, whereby the threading is carried out.

In each of the first to fifth cutting processes, the drive control unit 22 moves the tool holding unit 4 at a constant speed in the Z-axis direction in the relative relationship between the tool holding unit 4 and the workpiece and vibrates the tool holding unit 4 in the X-axis direction (workpiece radial direction) in accordance with the NC program. Consequently, the trajectory of the machining point of the tool 3a held by the tool holding unit 4 (the trajectory of the tip of the tool 3a in FIG. 1) draws a sinusoidal vibration waveform in the XZ plane. In this case, the five-time execution of the cutting process is programmed with G codes or M codes in the NC program such that the vibrations shown in FIG. 3 take place. That is to say, the drive control unit 22 precisely executes the contents of the command codes in the NC program. The drive control unit 22 itself does not set a new machining path, a new rotational speed, a new frequency, or the like.

On the other hand, when executing the command codes for the sixth (last) cutting process in the NC program, the drive control unit 22 only moves the tool holding unit 4 in the Z-axis direction, i.e., the drive control unit 22 does not vibrate the tool holding unit 4. That is to say, the command codes for the sixth (last) cutting process in the NC program are set such that the value of the address for the amplitude of the vibration of the tool 3a is set at 0, the address for the vibration of the tool 3a is deleted, or the address for the vibration of the tool 3a is to be ignored. Further, the command codes for the sixth (last) cutting process in the NC program are set such that the address for the X coordinate for setting the position of the tool holding unit 4 is set at a fixed value to maintain a constant position of the tool 3a in the X-axis direction. Consequently, the trajectory of the machining point of the tool 3a held by the tool holding unit 4 draws a straight line with a constant position on the X-axis in the XZ plane (the trajectory does not vibrate in the X-axis direction). This prevents the shape accuracy of the finished surface of the workpiece W from being lowered due to vibration of the tool 3a. Note that this finishing path with no vibration in the X-axis direction may be executed several times instead of being executed only in the last one of multiple cutting processes. The finishing path may be of a zero cut.

Note that the workpiece holding unit may be moved in the Z-axis direction instead of the tool holding unit 4 being moved in the Z-axis direction.

Here, the NC program is programmed such that the vibration waveforms drawn by the tip of the tool 3a in the XZ plane in the second and subsequent cutting processes partially intersect with one another. In FIG. 3, the NC program is programmed such that each waveform indicating the change in the depth of cut of the tool 3a on the X-axis with respect to the position change of the tool 3a on the Z-axis intersects with the vibration waveforms in the XZ plane in the previous and subsequent cutting processes (the previous and subsequent machining paths).

For instance, the vibration waveform drawn by the tool tip in the second cutting process (the dashed and dotted line in FIG. 3) is in the opposite-phase relationship with the vibration waveform drawn by the tool tip in the previous cutting process, i.e., the first cutting process (the solid line in FIG. 3). The troughs of the vibration waveform in the second cutting process are situated so as to intersect with the crests of the vibration waveform in the first cutting process. The phase difference between these waveforms in FIG. 3 is 180°; however, it is not limited thereto and can be set, for example, within a range of 90° to 270°. Further, the waveforms in the first and second cutting processes have the same cycle; however, they do not have to have the same cycle. One intersection between the two movement trajectories of the tool 3a is sufficient to achieve the chip breaking effect. Further, the NC program may be programmed such that the two movement trajectories of the tool 3a are in contact with each other instead of intersecting with each other.

Threading is preferably programmed such that cutting by the tool 3a is executed a plurality of times and, in each of the second and subsequent cutting processes, the vibration waveform indicating the relationship between the feed position of the tool 3a in the Z-axis direction and the position (depth of cut) of the tool 3a in the radial direction intersects with the vibration waveform in the previous cutting process in opposite phase.

In accordance with the thus-created NC program, in the cutting by the tool 3a, the portions deeply cut in the previous cutting process (i.e., the crests of the previous vibration waveform of the tool 3a) have no workpiece to be cut in the current cutting process. Therefore, the cutting of workpiece by the tool 3a is terminated and there are chips cut out up to the termination. Such chips can be regarded as being more broken than those in the conventional art. That is to say, returning the tool 3a to a cutting position identical to or shallower than the previous cutting position produces no-machining regions where cutting by the tool 3a does not take place. The machining point (cutting edge) of the tool 3a is separated from the workpiece W (including the state where the tool 3a is in contact with but cannot cut the workpiece W) due to the presence of such no-machining regions, whereby chips are broken. For easy understanding, the no-machining regions are indicated by hatching in FIG. 3. The foregoing description refers to an example where the crests and the troughs intersect with each other. However, even in the case where the crests and the troughs are in point contact with each other, no-machining points are produced and the cutting by the tool 3a is interrupted at the points; therefore, chips are broken.

Creating such an NC program including a vibration-related code can eliminate the need to separately provide a high-pressure coolant device that is needed for chip breaking in the conventional art.

Among NC programs including a vibration-related code, an NC program for threading preferably further includes a command code for decreasing the vibration amplitude of the tool holding unit 4 in the X-axis direction as the number of times execution of the cutting process increases. Thereby, the vibration amplitude of the vibration waveform of the tool tip is reduced. Where the peak amplitudes of the tool tip in the first to fifth cutting processes are respectively represented by A₁ to A₅, the peak-to-peak amplitudes in the first to fifth cutting processes are respectively represented by 2A₁ to 2A₅ that are twice the peak amplitudes. FIG. 3 shows these peak-to-peak amplitudes. It can be seen from FIG. 3 that the relationship of 2A₁>2A₂>2A₃>2A₄>2A₅ is satisfied.

Accordingly, the vibration amplitude of the tool 3a decreases as the number of times of execution of the cutting process increases (i.e., as the threading progresses from rough machining to finishing). This results in the vibration amplitude of the tool 3 being small in the finishing that is required to provide a high shape accuracy; consequently, the accuracy of the threading by the tool 3a is improved.

In view of the foregoing description, a method is described that enables a program including a vibration-related code to be easily created even with little experience of creating a program to be executed in the machine tool 1.

In this embodiment, two concepts, namely, an amplitude multiplying factor K and a frequency multiplying factor I, are introduced for the purpose of facilitating the NC program creation.

The amplitude multiplying factor K is defined as K=2Aₙ/Fₙ, where Fₙ is a depth of cut in the cutting process (n: the ordinal number of the cutting process). For instance, the amplitude multiplying factor K in the second cutting process in FIG. 3 is 2A₂/F₂=K≥1. In the following description, a region corresponding to the depth of cut Fₙ is referred to as “Fₙ region”. In the state shown in FIG. 3, the F₁ region and then F₂ region of the workpiece W are cut out. The F₁ region and the F₂ region are adjacent to each other. It can be seen from FIG. 3 that the cutting path in the second cutting process partially enters the F₁ region. Under this setting, the portions to be cut as the F₁ region of the workpiece (the hatched portions in FIG. 3) are cut away in the first cutting process. Accordingly, although the cutting path in the second cutting process enters the F₁ region, three is no workpiece W corresponding to the F₁ region since the workpiece W corresponding to the F₁ region has been cut away. Therefore, even though the tip of the tool 3a moves in accordance with a cutting command code in the NC program, the tip of the tool 3a just passes through the F₁ region without cutting the workpiece W.

In the example shown in FIG. 3, the amplitude multiplying factor K is set at a constant value (e.g., 1.2) in the second to fifth cutting processes. However, the present invention is not limited thereto. For example, codes in the NC program may be set such that the amplitude multiplying factor K decreases as the number of times of execution of the cutting process increases.

The frequency multiplying factor I is defined as the number of vibrations of the tool 3a during one rotation of the workpiece W. For example, where the frequency multiplying factor is 0.5, the tool 3a vibrates once every two rotations of the workpiece W.

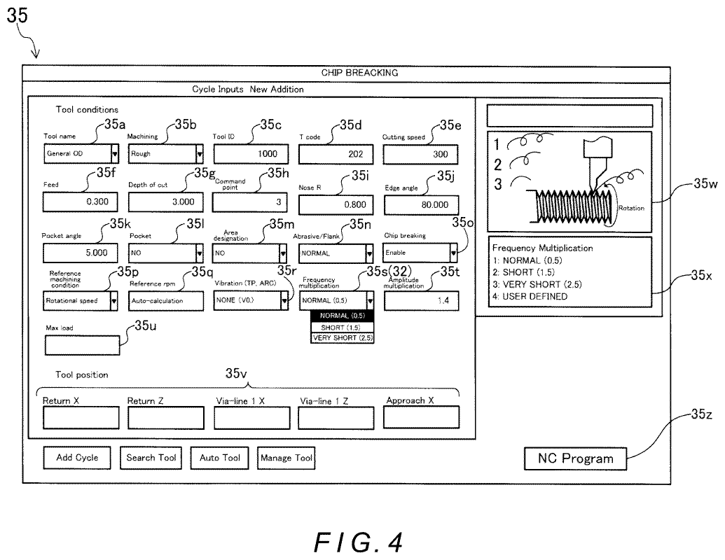

FIG. 4 shows a creation assistance screen for creating an NC program including these two conditions. In this embodiment, the frequency multiplying factor and the amplitude multiplying factor are displayed in a tool condition setting screen of the creation assistance screen for the NC program creation. However, the present invention is not limited thereto. The tool condition setting screen has input fields and selection fields for tool, tool number (T code), cutting speed, feed, depth of cut, command point, chip breaking, vibration axis, and other items. The tool condition setting screen in this embodiment further has a selection field for the frequency multiplying factor and an input field for the amplitude multiplying factor.

In the screen shown in FIG. 4, the selection field for the frequency multiplying factor is provided so as to select one from three options, namely, “NORMAL (0.5)”, “SHORT (1.5)”, and “VERY SHORT (2.5)” of a pull-down menu. In the screen shown in FIG. 4, the input field for the vibration multiplying factor has a numerical value of 1.2 input therein.

In the NC program creation, “Enable” is selected in the chip breaking selection field, a frequency multiplying factor is selected, an amplitude multiplying factor is input, and the other conditions on the creation assistance screen are input. Thereafter, an NC program button 35z that is displayed in the lower right area is pressed. Thereby, the input and selected information is transmitted to the programming unit 43. In addition to the information input on the creation assistance screen, the programming unit 43 obtains other necessary information on the machining, such as workpiece shape. The programming unit 43 makes calculations based on the obtained information, thereby creating an NC program. The created NC program is transmitted to and stored into the storage 42 of the second controller 40.

Once an operator operating the machine tool 1 selects the created program on the operation panel 30 and presses the program execution button 31 on the operation panel 30, the second controller 40 accepts the input from the operation panel 30 and transmits the NC program stored in the storage 42 to the first controller 20. Upon receiving the NC program, the first controller 20 analyzes the contents of the NC program and issues commands for driving the spindle drive unit 11 and the tool feed drive unit 10 in accordance with the NC program. Thereby, the movement of the tool 3a and workpiece W attached to the machine tool 1 is controlled so that the threading is performed. Thus, the machine tool 1 according to this embodiment enables even an operator not having accurate knowledge about vibration cutting or NC codes for vibration cutting to easily realize effective vibration cutting.

### (Modification 1)

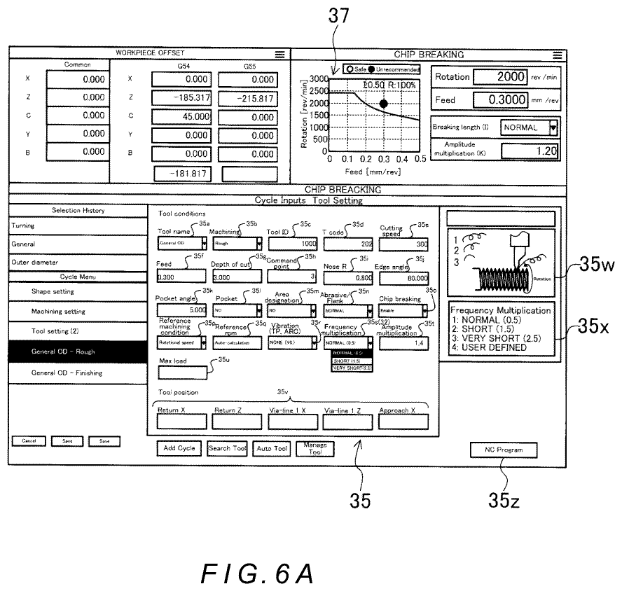

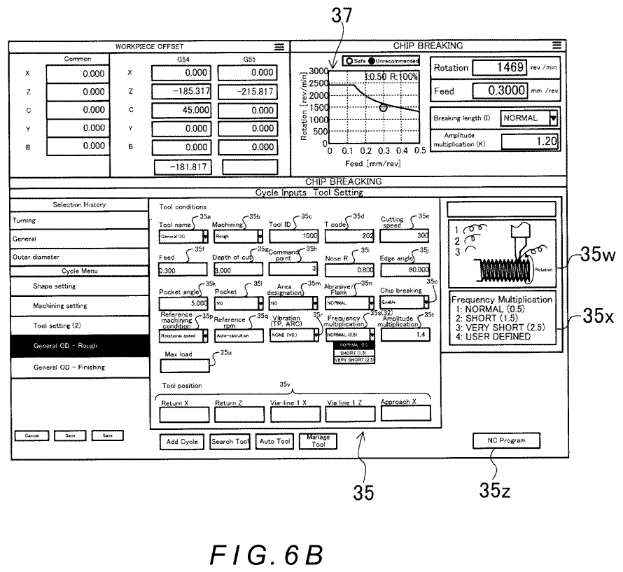

Program creation in this Modification 1 is assisted by interactive programming. The interactive program creation allows a program creator to create a program without understanding the details of G codes, etc. First, an application for interactive programming is activated as a program creation application (software). Thereby, an input screen 35 (see FIG. 6A) is displayed. The input screen 35 has items for interactive creation, such as shape setting, machining setting, measurement setting, and tool setting. Items necessary for a program to be created are selected and conditions are set for the selected items. At the end, an NC program is created by programming means based on the set conditions. For instance, once the shape setting is selected, a screen for inputting the profile of a part to be machined is displayed. On the screen, the profile of the part (finished product) is drawn. Thereby, information on the shape of the part to be machined is input and set. Of course, the shape information may be set by importing a CAD diagram of the part (finished product) instead of drawing the profile of the part. Thus, the shape information necessary for creation of the NC program is set on the shape setting screen. Necessary settings are similarly made according to the NC program to be created. For instance, to create an NC program for machining, the machining setting and the tool setting are also made in addition to the shape setting. Once the NC program button 35z is pressed at the end, the programming means creates an NC program based on the conditions (information) set in the shape setting, machining setting, and tool setting and outputs the created NC program.

In this Modification 1, the conditions for creating a vibration-related code are set on the tool setting input screen 35.

As shown in FIG. 4, the tool setting input screen 35 functions as a screen for setting information on the tool 3 (tool conditions, tool position, etc.). The input screen 35 shown in FIG. 4 has input boxes 35a to 35u for tool name, machining type, tool ID, T code, cutting speed, feed rate, depth of cut, command point, nose R, edge angle, pocket angle, pocket, area designation, flank wear, chip breaking, reference machining condition, reference rotational speed, vibration axis, frequency multiplying factor, amplitude multiplying factor, and maximum load value. The input screen 35 includes input boxes 35v for tool position. In the example shown in FIG. 4, the tool name “general OD (outer diameter)” is selected from a pull-down menu.

The input box 35r for “vibration axis” shown in the tool conditions is a pull-down type box for selecting whether to vibrate for the cutting tool 3 and selecting a direction to vibrate the cutting tool 3. In FIG. 4, “none (VO)” that indicates that the cutting tool 3 is not to be vibrated is displayed. For example, the vibration axis is displayed as follows: “X-axis (X0)” is displayed when vibration along the X-axis is selected; “Z-axis (Z0)” is displayed when vibration along the Z-axis is selected; and “X-axis Z-axis (XZ)” is displayed when two-axis simultaneous vibration along the X-axis and the Z-axis is selected. For example, it is also possible to display “Y-axis Z-axis (YZ)” to select two-axis simultaneous vibration along the Y-axis and the Z-axis. By touching the mark “▾” at the right end of the input box 35r, a pull-down menu with tabs of “X-axis (X0)”, etc. is displayed. The program creator selects the tab of his/her desired vibrating direction.

The input box 350 for “chip breaking” shown in the tool conditions is a pull-down type box for selecting whether to enable or disable the chip breaking function. That is to say, a pull-down menu with an “Enable” tab and an “Disable” tab is displayed by the mark “▾” at the right end of the input box 350 being touched. The operator selects one of the two tabs.

The input screen 35 has a first guidance field 35w in the upper right area thereof. The first guidance field 35w shows the contents of the input in a selected input box. The first guidance field 35w displays an image (a static image, a moving image, or the like) to allow the program creator to visually and intuitively recognize a settable condition. In FIG. 4, the first guidance field 35w displays an image from which it can be visually and intuitively recognized that the chip length changes in accordance with selection of the input in the frequency multiplying factor. The input screen 35 has a second guidance field 35x displayed below the first guidance field 35w. The second guidance field 35x shows the correspondence between the numerical value of the frequency multiplying factor I and the chip length level in execution of the chip breaking for shortening long chips. In this embodiment, the second guidance field 35x displays “NORMAL (0.5)”, “SHORT (1.5)”, and “VERY SHORT (2.5)” with respect to the chip length so that the chip length can be intuitively recognized. Further, the second guidance field 35x shows that there is a user-designated option to allow a program creator having deep experience in program creation to directly input a numerical value. Each numerical value in parentheses in the guidance field represents the numerical value of the frequency multiplying factor I corresponding to the respective chip length level. In this embodiment, this numerical value is to be written in the NC program to be created. Thus, the second guidance field 35x can function as an explanatory field for explaining the image displayed in the first guidance field 35w or as an explanatory field for supplementing the image displayed in the first guidance field 35w.

The program creator performs the input operation in the input box 35s while recognizing the relationship between the frequency multiplying factor I and the chip length level with reference to the contents shown in the first guidance field 35w and the second guidance field 35x. Specifically, for example, when the program creator wants to set the chip length to “NORMAL”, the program creator selects “NORMAL (0.5)” from the pull-down menu provided in the frequency multiplying factor input box 35s. In this embodiment, the pull-down menu with the three options of “NORMAL (0.5)”, “SHORT (1.5)”, and “VERY SHORT (2.5)” is displayed by the program creator selecting (touching) the mark “▾” provided at the right end of the frequency multiplying factor input box 35s. The program creator selects one of these three options. When the program creator wants to input a desired numerical value, the program creator can input the numerical value from the keyboard by moving the cursor to the input box to select the input box (or touching the screen).

Once the NC program button 35z is pressed after completion of the setting operation on the input screen 35, an NC program is created by the programming means. The NC program itself is executable in various machine tools. Therefore, on the machine tool in which the NC program is to be input and executed, a screen may be displayed that allows the operator operating the machine tool 1 to easily and visually recognize whether the NC program is usable in the machine tool 1 to be used. The above-described input method enables even an operator not having accurate knowledge about vibration cutting or NC codes for vibration cutting to easily make settings for vibration cutting and easily create an NC program for executing the vibration cutting.

In this embodiment, before the NC program is created by the programming means, a check screen is displayed that allows the program creator or the operator operating the machine tool 1 to check whether the NC program to be created is usable in the machine tool 1 in which the NC program is to be executed. For example, by pressing the cycle check button after the necessary settings are made on the input screen 35, a graphic check screen 37 showing whether the NC program is safely usable in the machine tool 1 is displayed on the display unit 32 based on the feed rate input in the input box 35f, the vibration conditions input in the input boxes 35r to 35t, an automatically calculated value of the rotation speed of the spindle 2, etc.

FIGS. 6A and 6B show examples of the graphic check screen 37 displayed on the display unit 32. In these examples of the graphic check screen 37, a line separating a safe region and an unrecommendable region is displayed in a graph with the rotation speed on the vertical axis and the feed rate on the horizontal axis. The safe region means a region where the machining is to be performed with no unnecessary load applied to the machine tool 1 or the tool. The unrecommendable region means a region where the machining is to be performed with an unnecessary load applied to the machine tool 1 or the tool. For example, a load applied to the tool 3a shortens the life of the tool 3a, which results in increase in the number of times of tool replacement. Therefore, it is desirable that machining is performed with no unnecessary load. In this embodiment, whether the relationship between the rotation speed and feed rate to be set is recommendable or not is graphically displayed. However, a recommendable relationship between the rotation speed and feed rate may be numerically displayed.

The display control unit 41 plots and displays on the graph a value calculated based on the conditions set on the input screen and so on. When the plot is positioned in the unrecommendable region that is located on the upper side of the separating line, the display control unit 41 displays the plot with a black circle (see FIG. 6A). On the other hand, when the plot is positioned in the safe region that is located below the separating line, the display control unit 41 displays the plot with a white circle (see FIG. 6B). As shown in FIGS. 6A and 6B, the rotation speed of the spindle 2, the feed rate of the tool 3a, the chip breaking length, and the amplitude multiplying factor K that were the basis for the calculation of the operating point are displayed on the right of the graphic check screen 37. Upon confirming through this display that the NC program is safely executable in the machine tool 1 to be used, the program creator presses the NC program button 35z to cause the programming means to create the NC program. In the case where the NC program has already been created, the operator operating the machine tool 1 presses the program execution button 31 after confirming that the NC program is safely executable in the machine tool 1 to be used. Once the program execution button 31 is pressed, the first controller 20 of the machine tool 1 analyzes the NC program and transmits commands to the spindle drive unit 11 and the tool feed drive unit 10, whereby the machining in accordance with the NC program is carried out in the machine tool 1.

In order to carry out machining or the like in the machine tool 1, it is necessary to create an NC program. Therefore, the programming unit 43 creates an NC program based on specification values input through the input screen 35. In this process, where the chip breaking function is enabled, the programming unit 43 creates a vibration-related code based on at least the set values of the vibration axis, frequency multiplying factor I, and amplitude multiplying factor K and creates an NC program including the code. The programming unit 43 transmits the created NC program to the first controller 20. The first controller 20 analyzes the received NC program and transmits drive signals to the spindle drive unit 11 and the tool feed drive unit 10, thereby causing the machine tool 1 to machine the workpiece W.

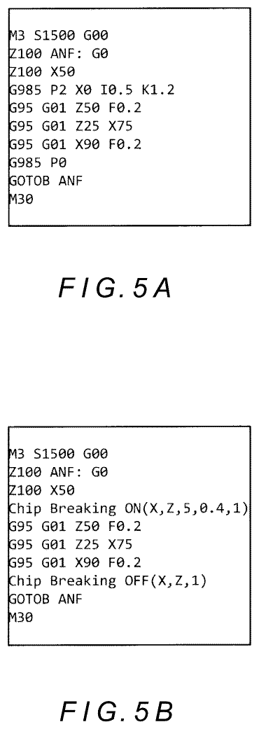

FIG. 5A shows an example of the NC program created by the programming unit 43. In this example, a vibration-related code “G985 P2 X0 I0.5 K1.2” is incorporated at the fourth line. In this vibration-related code, P2 turns on (enables) the chip breaking function; X0 sets the vibration direction to the X-axis; 10.5 sets the frequency multiplying factor I to 0.5; and K1.2 sets the amplitude multiplying factor K to 1.2. Note that the chip breaking function can be turned off (enabled) by changing P2 to P0. The vibration direction can be set to the Z-axis by changing X0 to Z0. The code “G985 P0” at the third line from the last is a code for turning off the chip breaking function.

In the NC program example shown in FIG. 5A, the blocks coincide with the lines. Therefore, the example is described with respect to the lines.

As shown in another program example in FIG. 5B, a chip breaking code “Chip Breaking ON (LXX, LZZ, Frequency, Amplitude, ID)” may be used instead of the G code.

In this example, LXX represents the X-axis; LZZ represents Z-axis; Frequency represents a frequency of a sin² function as a vibration function per spindle rotation; Amplitude represents an amplitude of the sin² function; and ID represents a static synchronous action number necessary for activating and periodically calling a technology cycle.

Where the chip breaking function is enabled on the input screen 35, the programming means inserts the chip breaking code into the NC program. Where the X-axis and the Z-axis are selected in the vibration axis, the programming means sets LXX and LZZ. Further, the programming means converts the value set in the frequency multiplying factor into the corresponding frequency and replaces and sets “Frequency” with the numerical value, and converts the value set in the amplitude multiplying factor into the corresponding amplitude and replaces and sets “Amplitude” with the numerical value.

Thus, the machine tool 1 according to this embodiment enables even an operator not having accurate knowledge about vibration cutting or NC codes for vibration cutting to easily create an NC program for executing vibration cutting and easily carry out effective vibration cutting.

### (Modification 2)

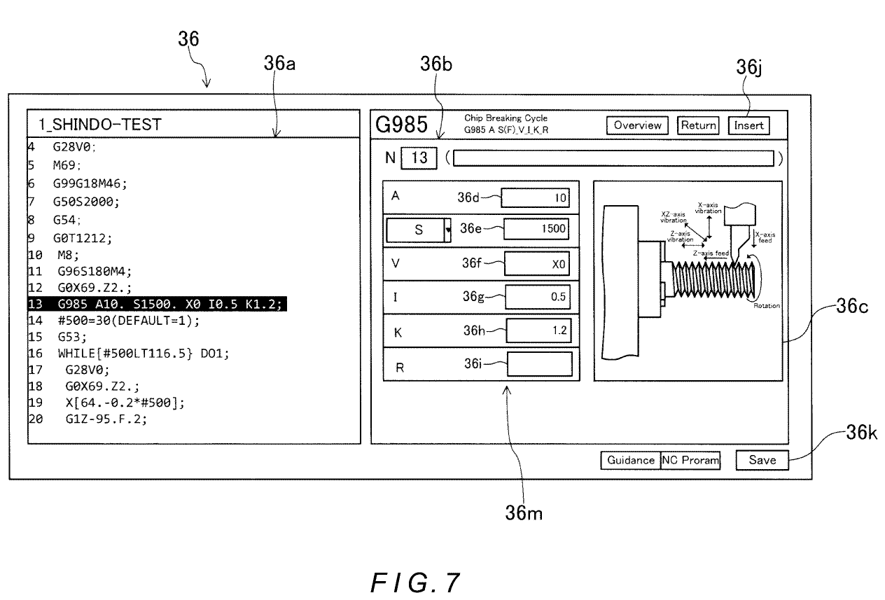

The second controller 40 in this Modification 2 includes programming means that includes code insertion means capable of executing a process of inserting a chip breaking function code into an NC program upon receipt of an input in a guidance screen 36 displayed on the display unit 32 (see FIG. 7). That is to say, the second controller 40 has, in addition to the display control unit 41 and the storage 42, a programming unit 43 (an example of the programming means) including a code insertion unit 44 (an example of the code insertion means).

Once a program editing function is activated on the operation panel 30, the display control unit 41 displays a program editing screen on the display unit 32. A program editor may directly edit a program by displaying the program and selecting a portion to be edited. However, in this Modification, a selection screen is displayed that displays icons for technology cycles to select a function to be edited. The selection screen displays icons for technology cycles such as chip breaking, multi-threading 2.0, keyway broaching, application tuning cycle, and gear hobbing to select a function to be edited. Once a function is selected, the display control unit 41 displays on the display unit 32 the guidance screen 36 for the function selected on the editing screen. FIG. 7 shows a state where the chip breaking of the technology cycles is selected and the guidance screen 36 for the chip breaking is displayed.

The guidance screen 36 shown in FIG. 7 has a window of a program display field 36a on the left side thereon and has a window of a guidance field 36b on the right side thereon.

The program display field 36a displays an NC program input from the keyboard, an NC program stored in the storage 21, or the like. The program display field 36a in FIG. 7 displays the NC program for threading called from the storage 21.

The guidance field 36b includes an image field 36c that displays an image (a static image, a moving image, or the like) showing the function selected from the technology cycles and also displays an explanatory text about the selected function or guidance on how to input.

The guidance field 36b further includes a guidance input field 36m. The guidance input field 36m in FIG. 7 has six input boxes 36d to 36i.

The image field 36c in FIG. 7 displays an image that allows the positional relationship between the workpiece W and the tool 3a, the rotation direction of the workpiece W, and the movement and vibration of the tool 3a to be visually recognized. The image field 36c makes it easy to visually recognize the chip breaking function, and the explanation and input guidance displayed around the image make it easy to input and set numerical values to be set in the guidance input field 36m.

The guidance input field 36m in FIG. 7 has six input boxes 36d to 36i arranged in sequence from top to bottom. On the left of each of the input boxes 36d to 36i, an alphabet letter (“A”, “S”, “V”, “I”, “K”, “R” in this example) corresponding to the contents of the specification value to be input is displayed. The letter “S” represents the rotational speed of the spindle 2. The letter “I” represents the frequency multiplying factor described above. The letter “K” represents the amplitude multiplying factor described above.

In the example shown in FIG. 7, 2000 (rpm) is input in the input box 36e for specifying the rotational speed of the spindle 2, 0.5 is input in the input box 36g for specifying the frequency multiplying factor I, and 1.2 is input in the input box 36h for specifying the amplitude multiplying factor K.

Based on the frequency multiplying factor I, the amplitude multiplying factor K, and so on input through the guidance screen 36, a vibration-related code is created. The created code is inserted at a line selected in the program display field 36a by the operator operating the machine tool 1. The selection of the line by the operator corresponds to a step of setting a position in the NC program at which a G code or an M code is to be inserted (first step). The step of inputting the vibration components such as the frequency multiplying factor I and the amplitude multiplying factor K through the guidance screen 36 corresponds to a step of making a setting for applying a vibration component in the thread radial direction to the movement path of the tool 3a (second step). Note that the selection of the line by the operator is not limited to the touching operation and may be performed by a cursor key operation. The code insertion unit 44 identifies based on a signal of the touching operation or cursor operation the position of the line (or the block number) at which the code is to be inserted. Upon receiving an operation signal of an insertion button 36j provided in the upper right area of the guidance screen 36 after identifying the position of the line, the code insertion unit 44 executes insertion of the vibration-related code at the specified line in the NC program. The operation signal of the insertion button 36j corresponds to an instruction for reflecting the vibration component setting in the NC program.

In FIG. 7, a vibration-related code is inserted at the line 13 (the block number is also 13 in this example) in the NC program for threading displayed in the program display field 36a. The inserted line as a whole is indicated with a black label and the operation command code characters therein are displayed in white.

Upon receiving an operation signal of a save button 36k that is provided in the lower right area of the guidance screen 36, the code insertion unit 44 stores the changed NC program with the vibration-related code inserted therein into the storage 42 of the second controller 40.

Upon receiving an NC program execution command (a command indicating that the program execution button 31 has been pressed) from the operation panel 30, the drive control unit 22 controls the operations of the spindle drive unit 11 and tool feed drive unit 10 in accordance with the NC program stored in the storage 21. Thereby, cutting by the tool 3a is performed a plurality of times while the tool 3a is vibrated in the X-axis direction based on the vibration conditions input by the operator.

This Modification enables the operator to insert his/her desired code at a predetermined line (or block) in the NC program while looking at the NC program displayed in the program display field 36a of the guidance screen 36. Consequently, the programming burden on the operator operating the machine tool 1 is reduced.

### Other Embodiments

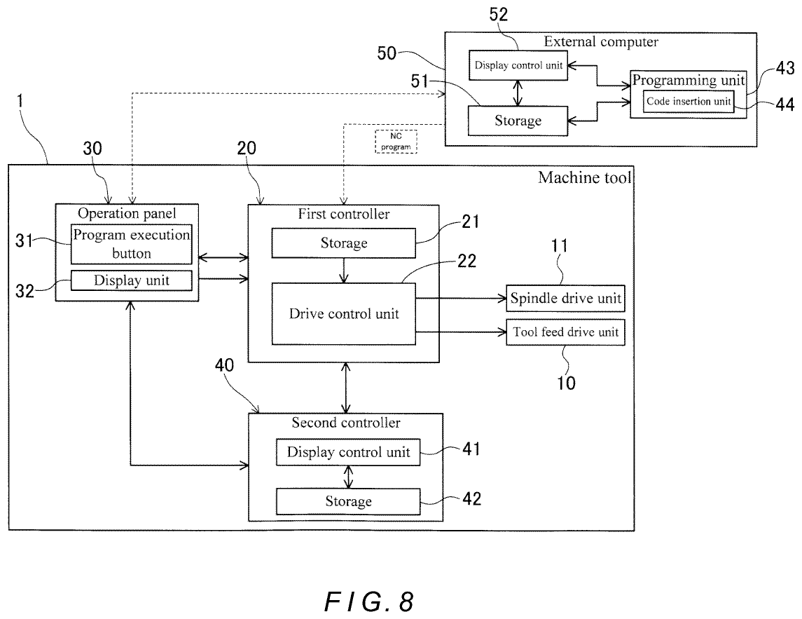

In the above-described embodiment, the programming unit 43 is mounted in the second controller 40. However, the present invention is not limited thereto. For example, the programming unit 43 may be mounted in an external computer 50 as shown in FIG. 8. In this case, a display control unit 52 of the external computer 50 displays the input screen 35 on the display unit 32 of the operation panel 30. The programming unit 43 of the external computer 50 creates an NC program based on vibration conditions input through the input screen 35. The programming unit 43 transmits the created NC program to the first controller 20 to store the NC program into the storage 21.

As shown in FIG. 8, the code insertion unit 44 that is mounted in the second controller 40 in the above-described embodiment also may be mounted in the external computer 50.

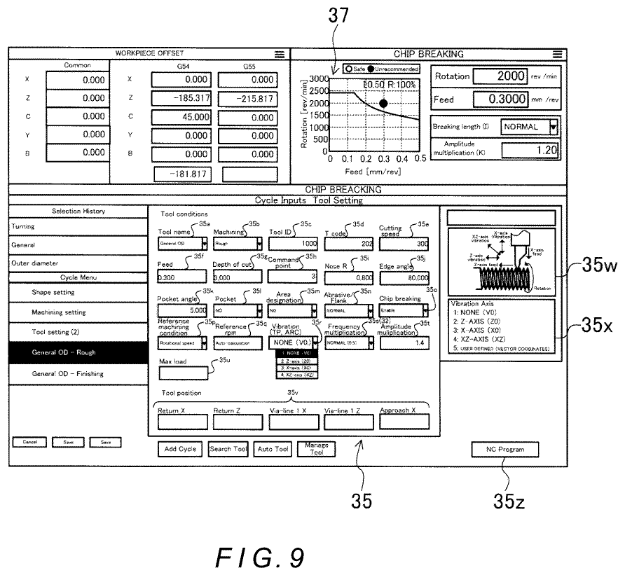

The second guidance field 35x of the input screen 35 displays the correspondence between the numerical value of the frequency multiplying function I and the chip length level in execution of the chip breaking. However, the present invention is not limited thereto. As shown in FIG. 9, information for assisting the selection of the vibration axis may be displayed in the second guidance field 35x by the vibration axis input box 35r being selected. In this case, the image displayed in the first guidance field 35w and the contents displayed in the second guidance field 35x allows the program creator to easily and visually recognize the vibration axis to be selected in the vibration cutting control.

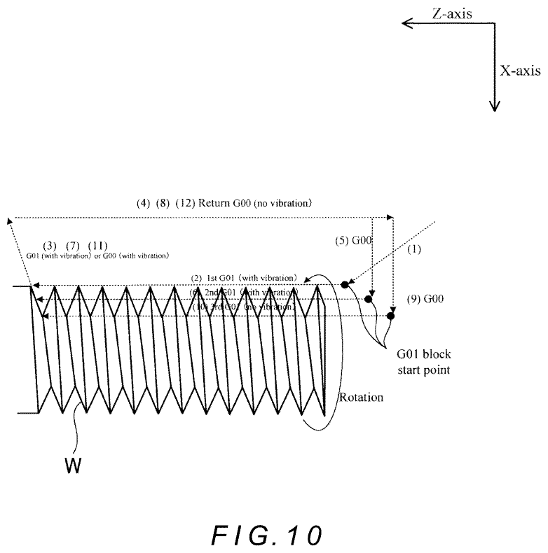

FIG. 10 shows another example of the cutting paths (or the movement trajectories of the machining point) in the vibration threading. The code “G00” in the NC program is an exemplary code for moving the tool holding unit without turning on the vibration mode. The code “G01” is an exemplary code for moving the tool holding unit while vibrating the tool holding unit (in the X-axis direction) with the vibration mode turned on.

First, “G00 coordinates X Y Z;” is set to move the tool holding unit 4 to the coordinates X Y Z without vibrating the tool holding unit 4 (1). Subsequently, “G985 A10 ◯◯ ◯◯;” is set in the next block to turn on the vibration mode, and “G01 coordinates;” is set in the further next block to move the tool holding unit 4 to the coordinates in the G01 block while vibrating the tool holding unit 4 (2). Subsequently, the tool 3a is retracted from the workpiece W. Where there is a possibility that the tool 3a cuts the workpiece W in the retraction path, a code “G01 coordinates;” or a code “G00 coordinates;” is set with the vibration maintained to move the tool holding unit 4 (3). Subsequently, the tool 3a is moved from the left to the right in FIG. 10. In this movement, a block “G985 A0 ◯◯;” is set to turn off the vibration and a block “G00 coordinates;” is set to move the tool holding unit 4 to the coordinates (4). Thus, the vibration is turned off in the cutting path where the workpiece W is not cut by the tool 3a. This reduces the load applied to the machine tool 1, so that the machine tool 1 can operate for a long period of time. Subsequently, a block “G00 coordinates;” is set to move the tool holding unit 4 downward (5). Subsequently, blocks “G01 coordinates;” and “G985 A10 ◯◯ ◯◯;” are written in the NC program to start the second cutting that is performed with the tool holding unit 4 vibrated (6). Note that the start point of the first cutting path and the start point of the second cutting path have different X coordinates and Z coordinates. With a long distance set between the start point of the cutting path and the point at which the tool 3a actually starts to cut the workpiece W, moving the tool holing unit 4 after turning on the vibration mode at the start point allows the vibration to be stabilized during a certain distance of movement.

Subsequently, the tool 3a is retracted from the workpiece W. Where the tool 3a and the workpiece W is in a positional relationship such that the tool 3a does not come into contact with the workpiece W, a block “G985 A0, ◯◯;” is set to turn off the vibration, and then “G01 coordinates;” or “G00 coordinates;” is set to move the tool holding unit 4 (7). Subsequently, “G00 coordinates” is set without turning on the vibration to return the tool holding unit 4 to the cutting path start point side (8). Subsequently, the tool 3a is moved to the start point of the third cutting path (9). Subsequently, the third cutting is started without applying vibration (10). Threading is carried out by repeating cutting in this manner. The start point of the third cutting path has X and Z coordinates different from those of the start points of the first and second cutting paths. For example, setting the Z coordinate of the start point of the cutting path for finishing to a position away from the workpiece W enables an NC program to be created such that the operator can recognize execution of the finishing even when the operator observes the inside through a window of the machine tool 1.

It should be noted that the foregoing description of the embodiments is not limitative but illustrative in all aspects. One skilled in the art would be able to make variations and modifications as appropriate. The scope of the invention is not defined by the above-described embodiments, but is defined by the appended claims. Further, the scope of the invention encompasses all modifications made from the embodiments within a scope equivalent to the scope of the claims.

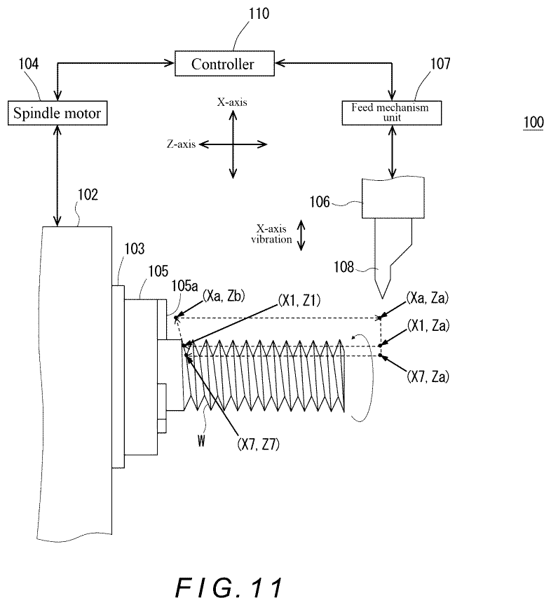

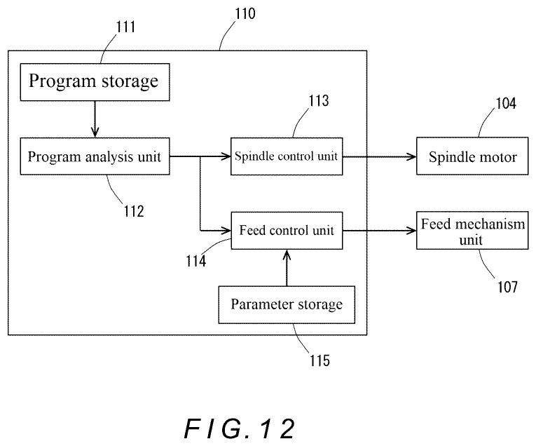

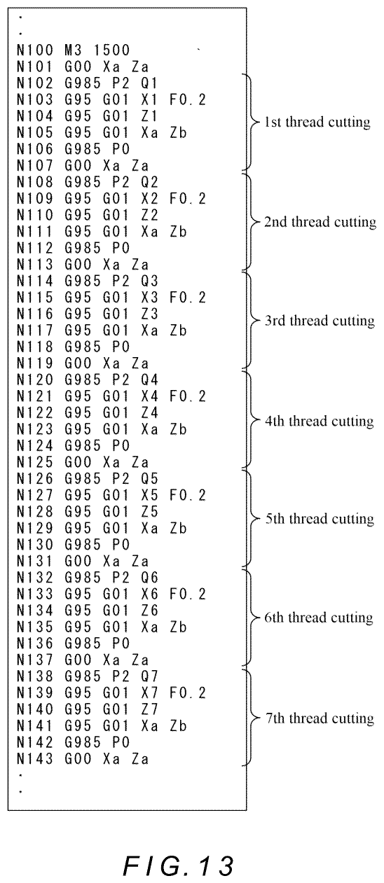

A reference mode of threading is described below. FIG. 11 is a plan view showing a principal configuration of a motion mechanism system of a machine tool in this reference mode. FIG. 12 is a block diagram showing a principal configuration of a control system of the machine tool.

As shown in FIGS. 11 and 12, the machine tool 100 in this mode is an NC lathe that turns a workpiece W with a tool 108. Such an NC lathe is typically capable of performing outer diameter machining, inner diameter machining, end face machining, drilling, grooving, threading, etc. on the workpiece W. The NC lathe in this mode is particularly designed to be capable of preferably performing threading.

As shown in FIG. 11, the machine tool 100 has a spindle 103, a headstock 102, a spindle motor 104, a tool rest 106, a feed mechanism unit 107, and a controller 110. The spindle 103 has a chuck 105 mounted on the distal end thereof. The headstock 102 holds the spindle 103 such that the spindle 103 is rotatable about an axis. The spindle motor 104 rotates the spindle 103. The tool rest 106 functions as a tool holding unit holding the tool 108. The feed mechanism unit 107 moves the tool rest 106. The controller 110 functions as a control unit controlling the operations of the spindle motor 104 and feed mechanism unit 107.

The chuck 105 has a plurality of (typically, three) clamp jaws 105a arranged so as to approach each other and separate from each other. The workpiece W is clamped (held) by the clamp jaws 105a. The chuck 105 functions as a workpiece holding unit holding the workpiece W. The spindle motor 104 functions as a rotation drive unit rotating the chuck 105 together with the spindle 103.

The feed mechanism unit 107 includes a Z-axis feed mechanism (not illustrated) and an X-axis feed mechanism (not illustrated). The Z-axis feed mechanism moves the tool rest 106 in the Z-axis direction that extends along the axis of the spindle 103. The X-axis feed mechanism moves the tool rest 106 in the X-axis direction that is perpendicular to the Z-axis. The feed mechanism unit 107 moves the tool rest 106 in the X-axis direction and the Z-axis direction under control by the controller 110.

As shown in FIG. 12, the controller 110 has a program storage 111, a program analysis unit 112, a spindle control unit 113, a feed control unit 114, and a parameter storage 115 that are principal units of the controller 110. Note that the controller 110 is composed of a computer including a CPU, a RAM, and a ROM. The program analysis unit 112, the spindle control unit 113, and the feed control unit 114 are functionally implemented by a computer program to execute the process described later. The program storage 111 and the parameter storage 115 are composed of an appropriate storage medium such as a RAM.

The program storage 111 is a functional unit that stores an NC program for machining the workpiece W. An appropriate NC program is input from the outside and stored into the program storage 111 in advance. A typical NC program has a structure in which NC codes are sequentially written on a block-by-block basis. For example, each block contains an NC code for rotation of the spindle 103, movement of the cutting edge (turning acting portion) of the tool 108, ON/OFF of coolant, etc. For instance, “M03” is an NC code (M code) defining normal rotation of the spindle 103. “M04” is an NC code (M code) defining reverse rotation of the spindle 103. “S ***” is an NC code (S code) defining the rotation speed of the spindle 103.

Further, “G00” is an NC code (G code) moving the tool 108 at a rapid feed rate. “G01” is an NC code (G code) moving the tool 108 at a set cutting feed rate. “F ****” is an NC code (F code) defining the feed rate of the tool 108. “X ****” and “Z ****” are NC codes defining the movement position of the cutting edge of the tool 108 in the workpiece coordinate system (X-Z coordinate system). In particular, “G985” as a G code defining threading with vibration is used in this mode. The operations of the spindle 103 and tool 108 are set (defined) with these NC codes, whereby one NC program is created.

The program analysis unit 112 is a functional unit that reads and executes an NC program stored in the program storage 111. The program analysis unit 112 recognizes (analyzes) the written NC codes while sequentially reading the NC program. The program analysis unit 112 transmits a control signal in accordance with the recognized NC code. When the recognized NC code relates to control of the rotation of the spindle 103, the program analysis unit 112 transmits a control signal corresponding to the NC code to the spindle control unit 113. When the recognized NC code relates to control of the feed in the feed mechanism unit 107, the program analysis unit 112 transmits a control signal corresponding to the NC code to the feed control unit 114.

The spindle control unit 113 controls the rotation, such as the rotation speed or the normal or reverse rotation direction, of the spindle motor 104 in accordance with the control signal transmitted from the program analysis unit 112.

The feed control unit 114 controls the operation of the feed mechanism unit 107 in accordance with the control signal transmitted from the program analysis unit 112. For example, the feed control unit 114 controls the speed (feed rate) for moving the tool 108 (speed control) and controls the movement position of the cutting edge of the tool 108 (position control).

The parameter storage 115 is a functional unit that stores values of the vibration amplitude (in this example, the peak amplitude) and values related to the vibration phase that are used when the feed control unit 114 executes the code “G985” defining threading. Data on these values is input from the outside and stored into the parameter storage 115 in advance.

In the machine tool 100 in this mode having the above-described configuration, under control by the controller 110, the spindle motor 104 and the feed mechanism unit 107 are operated in accordance with an appropriate NC program stored in the program storage 111 with the workpiece W clamped by the chuck 105, whereby the workpiece W clamped by the chuck 105 is turned by the tool 108. In this mode, threading with vibration of the tool 108 in the X-axis direction is performed by the above-described code “G985” defining threading being executed by the controller 10. The manner of the threading according to this mode is described below.

FIG. 11 is also an illustrative diagram of the threading according to this mode. In FIG. 11, a movement path of the cutting edge of the tool 108 (i.e., a tool path) is indicated by a broken line. In the threading according to this mode, as shown in FIG. 11, the cutting edge of the tool 108 is first positioned at the start position (Xa, Za). Subsequently, the cutting edge of the tool 108 is moved at a predetermined cutting feed rate in the X-axis direction to the first cutting position (X1, Za) and then moved at a feed rate per revolution (mm/rev) corresponding to the thread pitch to the position (X1, Z1). Thereby, the workpiece W is cut. Subsequently, the cutting edge of the tool 108 is moved to the relief position (Xa, Zb) and then returned to the start position (Xa, Za). Thereby, the first thread cutting is completed. Thereafter, the tool 108 is moved on a similar path with the tool 108 cutting in the workpiece W with a predetermined depth of cut. The thread cutting is performed a plurality of times, by way of example, seven times, on the workpiece W. Note that the number of times of the thread cutting is not limited to seven. It is preferable that the thread cutting is performed at least four times. The thread cutting may be performed eight times or more.

The tool paths for the multiple thread cuttings are as follows.
a) Thread cutting for first time (first thread cutting)

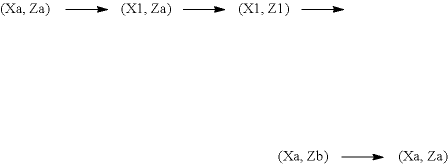

b) Thread cutting for second time (second thread cutting)

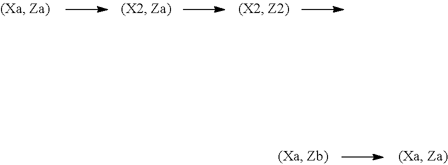

c) Thread cutting for third time (third thread cutting)

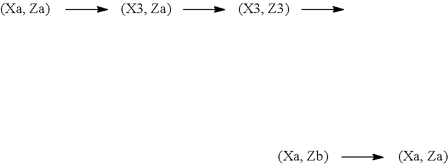

d) Thread cutting for fourth time (fourth thread cutting)

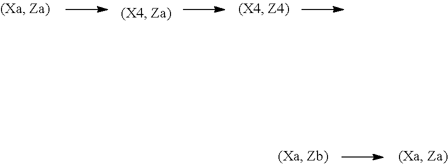

e) Thread cutting for fifth time (fifth thread cutting)

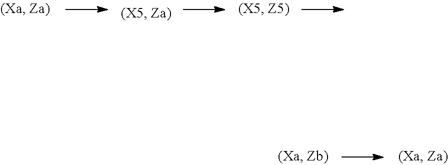

f) Thread cutting for sixth time (sixth thread cutting)

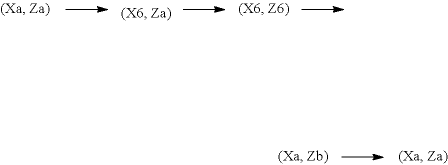

g) Thread cutting for seventh time (seventh thread cutting)

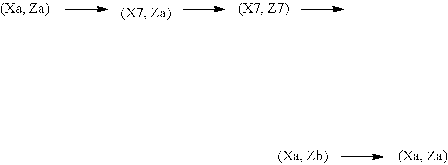

In this process, the feed control unit 114 vibrates the tool 108 in the X-axis direction with predetermined vibration amplitude and frequency and with a phase set with respect to the rotation phase (rotation angle) of the workpiece W at least during the cutting performed by moving the tool 108 along the Z-axis.

FIG. 13 shows an exemplary NC program for performing such threading. This NC program is an extract of blocks related to the threading and is a part of an NC program including other machining. The shown NC program corresponds to the above-described tool paths; therefore, the NC program executes seven thread cuttings, i.e., the first to seventh thread cuttings. “G985” is a code defining the vibration cutting. “P2” is a code defining enabling of the vibration cutting. “P0” is a code defining disabling of the vibration cutting. Executing the codes “G985” and “P2” enables the vibration cutting command. Executing the codes “G985” and “P0” disables the vibration cutting command. “Q*” is a code for the vibration conditions that refers to the vibration conditions stored in the parameter storage 15. “G95” is a code defining that the feed rate commanded by the F code is a feed rate per revolution. The feed rate commanded by the F code corresponds to one thread pitch.

Next, a first mode, a second mode, and a third mode of the threading with vibration cutting are described that are novel and useful machining modes and have not been disclosed in the conventional art.

### (First Mode)

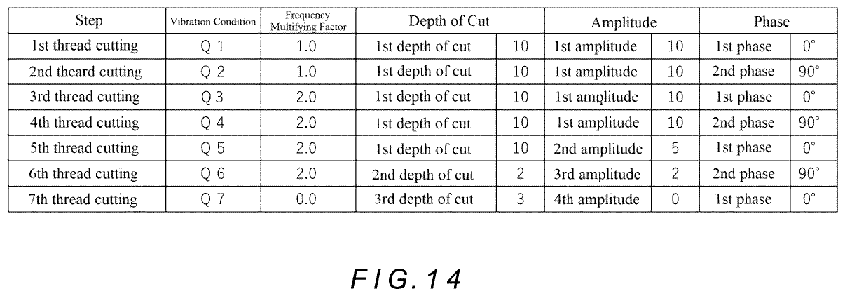

In this mode, vibration cutting is performed as described below in the first to seventh thread cuttings. The amplitude refers to the peak amplitude. As described above, the frequency multiplying factor is the number of vibrations of the tool 108 during one rotation of the workpiece W. The depth of cut in the first thread cutting is the distance in the radial direction between the outer peripheral surface of the workpiece W and the position of the center of vibration of the cutting edge of the tool 108. The depth of cut in the second thread cutting is the distance in the radial direction between the position of the center of vibration of the cutting edge of the tool 108 in the first thread cutting and the position of the center of vibration of the cutting edge of the tool 108 in the second thread cutting. As described above, the vibration conditions for each thread cutting are defined by the Q code (Q1 to Q7) and are stored in the parameter storage 15 (see FIG. 14). When executing the Q code, the feed control unit 114 controls the feed mechanism unit 107 with reference to the vibration conditions stored in the parameter storage 115, thereby vibrating the tool 108.

Referring to FIG. 14, the vibration cutting conditions are as follows. Note that the numerical values of the depth of cut and amplitude set in FIG. 14 are not absolute values but relative values. The absolute value of the total depth of cut in the threading corresponds to the distance between the thread crest and the thread root. The phase means the rotation angle of the workpiece W at which the vibration cutting is started. In this example, the depth of cut is specified in the NC program; therefore, it is not particularly necessary to store the depth of cut in the parameter storage 115.

### a) First Thread Cutting (Thread Cutting for First Time)

The vibration cutting conditions Q1 for the first thread cutting are set to: the frequency multiplying factor 1.0; a first depth of cut (relative value 10); a first amplitude (relative value 10); and a first phase (0°). The value of the first depth of cut is equal to the value of the first amplitude.

### b) Second Thread Cutting (Thread Cutting for Second Time)

The vibration cutting conditions Q2 for the second thread cutting are set to: the frequency multiplying factor 1.0; the first depth of cut (relative value 10); the first amplitude (relative value 10); and a second phase (90°). The second phase is shifted by 90° with respect to the first phase.

### c) Third Thread Cutting (Thread Cutting for Third Time)

The vibration cutting conditions Q3 for the third thread cutting are set to: the frequency multiplying factor 2.0; the first depth of cut (relative value 10); a second amplitude (relative value 5); and the first phase (0°).

### d) Fourth Thread Cutting (Thread Cutting for Fourth Time)

The vibration cutting conditions Q4 for the fourth thread cutting are set to: the frequency multiplying factor 2.0; the first depth of cut (relative value 10); the second amplitude (relative value 5), and the second phase (90°).

### e) Fifth Thread Cutting (Thread Cutting for Fifth Time)

The vibration cutting conditions Q5 for the fifth thread cutting are set to: the frequency multiplying factor 2.0; the first depth of cut (relative value 10), a third amplitude (relative value 2), and the first phase (0°).

### f) Sixth Thread Cutting (Thread Cutting for Sixth Time)

The vibration cutting conditions Q6 for the sixth thread cutting are set to: the frequency multiplying factor 2.0; a second depth of cut (relative value 2); the third amplitude (relative value 2); and the second phase (90°).

### g) Seventh Thread Cutting (Thread Cutting for Seventh Time)

The vibration cutting conditions Q7 for the seventh thread cutting are set to: the frequency multiplying factor 0.0; a second depth of cut (relative value 3); and no vibration (i.e., a fourth amplitude (relative value 0)).

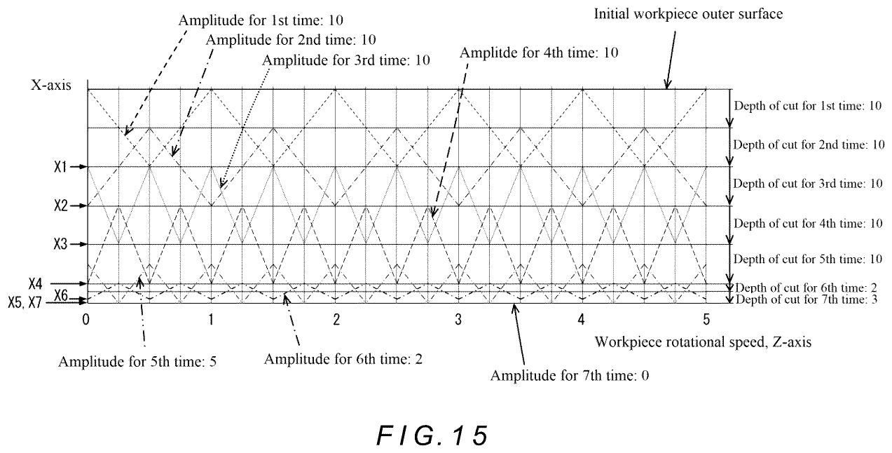

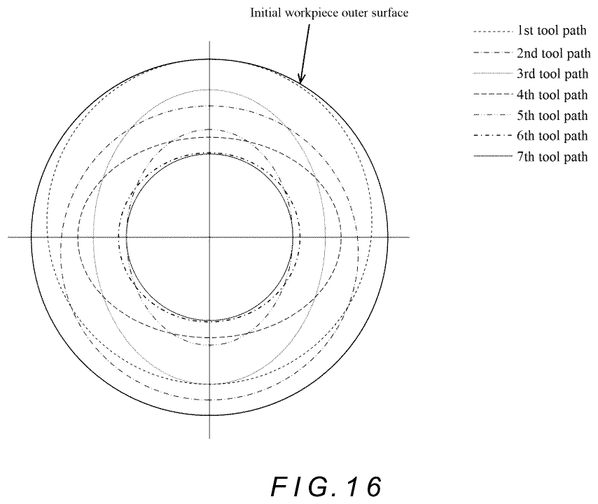

The movement paths of the cutting edge of the tool 108 (tool paths) in these thread cuttings are shown in FIGS. 15 and 16. In FIG. 15, the vertical axis represents the position of the cutting edge of the tool 108 in the X-axis direction (the radial direction), and the horizontal axis represents the position of the cutting edge of the tool 108 in the Z-axis direction (the axial direction) according to the rotation angle of the workpiece W. FIG. 16 shows the position of the cutting edge of the tool 108 in the X-axis direction (the radial direction) according to the rotation angle of the workpiece W, which corresponds to a view of the workpiece W as viewed in the axial direction thereof.

In this first mode, the vibration amplitude is set independently of the depth of cut in each of the first thread cutting (the thread cutting for the first time) to the seventh thread cutting (the thread cutting for the seventh time). Therefore, as shown in FIG. 15, the tool paths in the first to sixth thread cuttings are set such that two consecutive tool paths partially overlap with each other. This overlapping of the tool paths ensures breaking of chips. Further, the degree of the tool path overlapping can be set to be different for each thread cutting. For example, setting a large amplitude for the first to fourth thread cuttings and a smaller amplitude for the fifth and sixth thread cuttings as in this example enables gradual reduction of the cutting load while realizing breaking of chips.

In addition, since the tool 108 is not vibrated in the seventh thread cutting, the machined surface (thread groove surface) of the workpiece W machined by the tool 108 is finished with high surface accuracy.

In this first mode, the fifth and subsequent thread cuttings having no tool path overlapping are not always essential and may be omitted as appropriate.

### (Second Mode)

Also in this second mode, seven thread cuttings, i.e., the first thread cutting (the thread cutting for the first time) to the seventh thread cutting (the thread cutting for the seventh time), are performed. The depth of cut in the first thread cutting is the distance in the radial direction between the outer peripheral surface of the workpiece W and the position of the center of vibration of the cutting edge of the tool 108. The depth of cut in the second thread cutting is the distance in the radial direction between the position of the center of vibration of the cutting edge of the tool 108 in the first thread cutting and the position of the center of vibration of the cutting edge of the tool 108 in the second thread cutting. As described above, the vibration conditions for each thread cutting are defined by the Q code (Q11 to Q17) and are stored in the parameter storage 115 (see FIG. 7). When executing the Q code, the feed control unit 114 controls the feed mechanism unit 107 with reference to the vibration conditions stored in the parameter storage 115, thereby vibrating the tool 108.

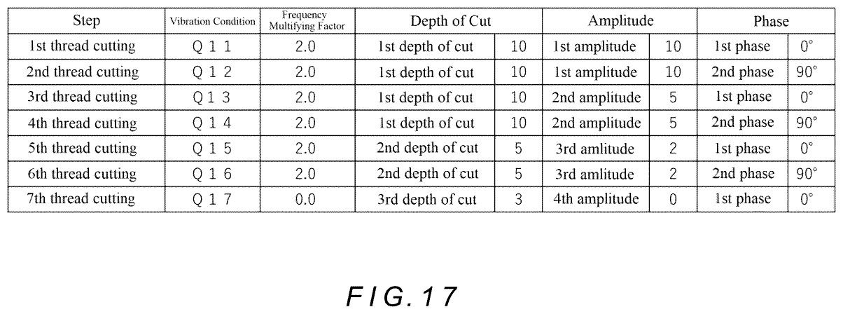

Referring to FIG. 17, the vibration cutting conditions are as follows. Note that the numerical values of the depth of cut and amplitude set in FIG. 17 are not absolute values but relative values. The absolute value of the total depth of cut in the threading corresponds to the distance between the thread crest and the thread root. The phase means the rotation angle of the workpiece W at which the vibration cutting is started. In this example, the depth of cut is specified in the NC program; therefore, it is not particularly necessary to store the depth of cut in the parameter storage 115.

### a) First Thread Cutting (Thread Cutting for First Time)

The vibration cutting conditions Q11 for the first thread cutting are set to: the frequency multiplying factor 2.0; a first depth of cut (relative value 10); a first amplitude (relative value 10); and a first phase (0°). The value of the first depth of cut is equal to the value of the first amplitude.

### b) Second Thread Cutting (Thread Cutting for Second Time)

The vibration cutting conditions Q12 for the second thread cutting are set to: the frequency multiplying factor 2.0; the first depth of cut (relative value 10); the first amplitude (relative value 10); and a second phase (90°). The second phase is shifted by 90° with respect to the first phase.

### c) Third Thread Cutting (Thread Cutting for Third Time)

The vibration cutting conditions Q13 for the third thread cutting are set to: the frequency multiplying factor 2.0; the first depth of cut (relative value 10); a second amplitude (relative value 5); and the first phase (0°).

### d) Fourth Thread Cutting (Thread Cutting for Fourth Time)

The vibration cutting conditions Q14 for the fourth thread cutting are set to: the frequency multiplying factor 2.0; the first depth of cut (relative value 10); the second amplitude (relative value 5), and the second phase (90°).

### c) Fifth Thread Cutting (Thread Cutting for Fifth Time)

The vibration cutting conditions Q15 for the fifth thread cutting are set to: the frequency multiplying factor 2.0; a second depth of cut (relative value 5), a third amplitude (relative value 2), and the first phase (0°).

### f) Sixth Thread Cutting (Thread Cutting for Sixth Time)

The vibration cutting conditions Q16 for the sixth thread cutting are set to: the frequency multiplying factor 2.0; the second depth of cut (relative value 5); the third amplitude (relative value 2); and the second phase (90°).

### g) Seventh Thread Cutting (Thread Cutting for Seventh Time)

The vibration cutting conditions Q17 for the seventh thread cutting are set to: the frequency multiplying factor 0.0; a third depth of cut (relative value 3); and no vibration (i.e., a fourth amplitude (relative value 0)).

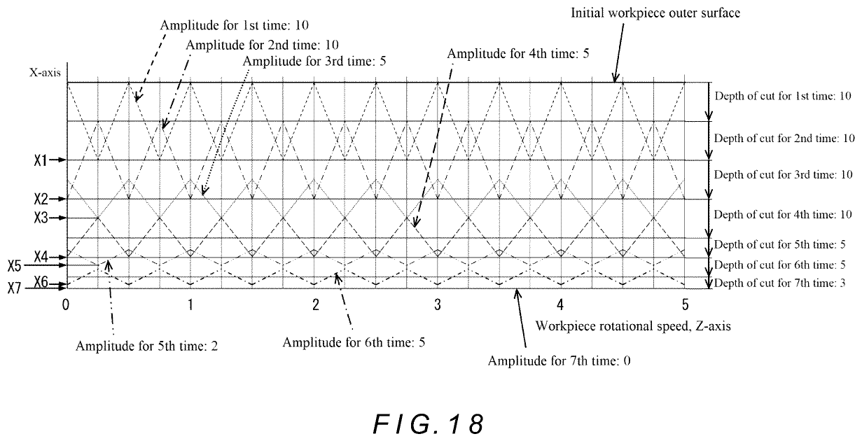

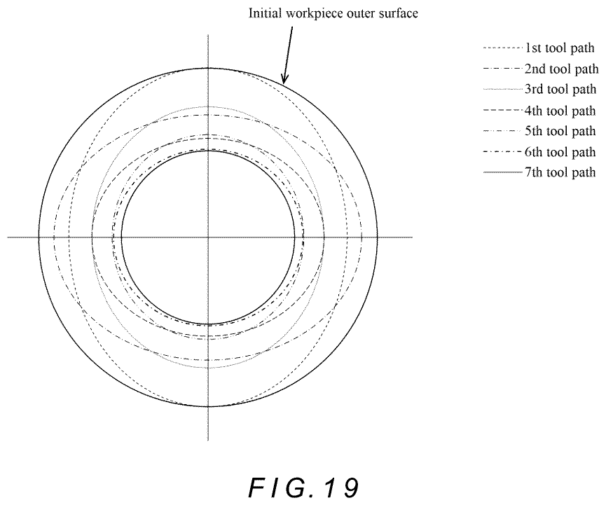

The movement paths of the cutting edge of the tool 108 (tool paths) in these thread cuttings are shown in FIGS. 18 and 19. In FIG. 18, the vertical axis represents the position of the cutting edge of the tool 108 in the X-axis direction (the radial direction), and the horizontal axis represents the position of the cutting edge of the tool 108 in the Z-axis direction (the axial direction) according to the rotation angle of the workpiece W. FIG. 19 shows the position of the cutting edge of the tool 108 in the X-axis direction (the radial direction) according to the rotation angle of the workpiece W, which corresponds to a view of the workpiece W as viewed in the axial direction thereof.

Also in this second mode, the vibration amplitude is set independently of the depth of cut in each of the first thread cutting to the seventh thread cutting. Therefore, as shown in FIG. 18, the tool paths in the first to fifth thread cuttings are set such that two consecutive tool paths partially overlap with each other. This overlapping of the tool paths ensures breaking of chips. Further, the degree of the tool path overlapping can be set to be different for each thread cutting. For example, setting a large amplitude for the first and second thread cuttings, a smaller amplitude for the third and fourth thread cuttings, and a further smaller amplitude for the fifth thread cutting as in this example enables gradual reduction of the cutting load while realizing breaking of chips.

On the other hand, the tool paths in the sixth and seventh thread cuttings are set such that two consecutive tool paths do not overlap with each other. Also in this case, depending on the material of the workpiece W and the shape of the tool, chips are broken at the portions where the tool paths approach each other. Therefore, it is possible to set a small vibration amplitude so as to reduce the load applied to the spindle motor 4 and feed mechanism 7 of the machine tool 1. In addition, since the tool 8 is not vibrated in the seventh thread cutting, the machined surface (thread groove surface) of the workpiece W machined by the tool 108 is finished with high surface accuracy.

In this second mode, the fifth and subsequent thread cuttings are not always essential and may be omitted as appropriate.

### (Third Mode)

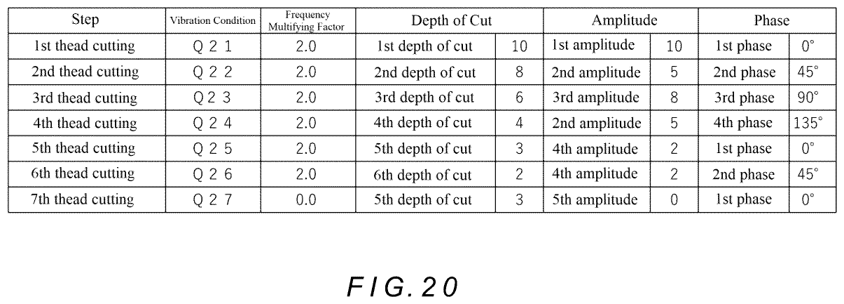

Also in this third aspect, seven thread cuttings, i.e., the first thread cutting to the seventh thread cutting are performed. The number of vibrations per one rotation of the workpiece W is set to be the same value, i.e., 2, for all the thread cuttings. The amplitude refers to the peak amplitude. The depth of cut in the first thread cutting is the distance in the radial direction between the outer peripheral surface of the workpiece W and the position of the center of vibration of the cutting edge of the tool 108. The depth of cut in the second thread cutting is the distance in the radial direction between the position of the center of vibration of the cutting edge of the tool 108 in the first thread cutting and the position of the center of vibration of the cutting edge of the tool 108 in the second thread cutting. As described above, the vibration conditions in each thread cutting are defined by the Q code (Q21 to Q27) and are stored in the parameter storage 115 (see FIG. 20). When executing the Q code, the feed control unit 114 controls the feed mechanism unit 107 with reference to the vibration conditions stored in the parameter storage 115, thereby vibrating the tool 108.

Referring to FIG. 20, the vibration cutting conditions are as follows. Note that the numerical values of the depth of cut and amplitude set in FIG. 20 are not absolute values but relative values. The absolute value of the total depth of cut in the threading corresponds to the distance between the thread crest and the thread root. The phase means the rotation angle of the workpiece W at which the vibration cutting is started. In this example, the depth of cut is specified in the NC program; therefore, it is not particularly necessary to store the depth of cut in the parameter storage 115.

### a) First Thread Cutting (Thread Cutting for First Time)

The vibration cutting conditions Q21 for the first thread cutting are set to: the frequency multiplying factor 2.0; a first depth of cut (relative value 10); a first amplitude (relative value 10); and a first phase (0°). The value of the first depth of cut is equal to the value of the first amplitude.

### b) Second Thread Cutting (Thread Cutting for Second Time)

The vibration cutting conditions Q22 for the second thread cutting are set to: the frequency multiplying factor 2.0; a second depth of cut (relative value 8); a second amplitude (relative value 5); and a second phase (45°). The second phase is shifted by 45° with respect to the first phase.

### c) Third Thread Cutting (Thread Cutting for Third Time)

The vibration cutting conditions Q23 for the second thread cutting are set to: the frequency multiplying factor 2.0; a third depth of cut (relative value 6); a third amplitude (relative value 8); and a third phase (90°). The third phase is shifted by 45° with respect to the second phase and by 90° with respect to the first phase.

### d) Fourth Thread Cutting (Thread Cutting for Fourth Time)

The vibration cutting conditions Q24 for the fourth thread cutting are set to: the frequency multiplying factor 2.0; a fourth depth of cut (relative value 4); the second amplitude (relative value 5); and a fourth phase (135°). The fourth phase is shifted by 45° with respect to the third phase, by 90° with respect to the second phase, and by 135° with respect to the first phase.

### e) Fifth Thread Cutting (Thread Cutting for Fifth Time)

The vibration cutting conditions Q25 for the fifth thread cutting are set to: the frequency multiplying factor 2.0; a fifth depth of cut (relative value 3), a fourth amplitude (relative value 2), and the first phase (0°).

### f) Sixth Thread Cutting (Thread Cutting for Sixth Time)

The vibration cutting conditions Q26 for the sixth thread cutting are set to: the frequency multiplying factor 2.0; a sixth depth of cut (relative value 2); the fourth amplitude (relative value 2); and the second phase (45°).

### g) Seventh Thread Cutting (Thread Cutting for Seventh Time)

The vibration cutting conditions Q27 for the seventh thread cutting are set to: the frequency multiplying factor 0.0; the fifth depth of cut (relative value 3); and no vibration (i.e., a fifth amplitude (relative value 0)).

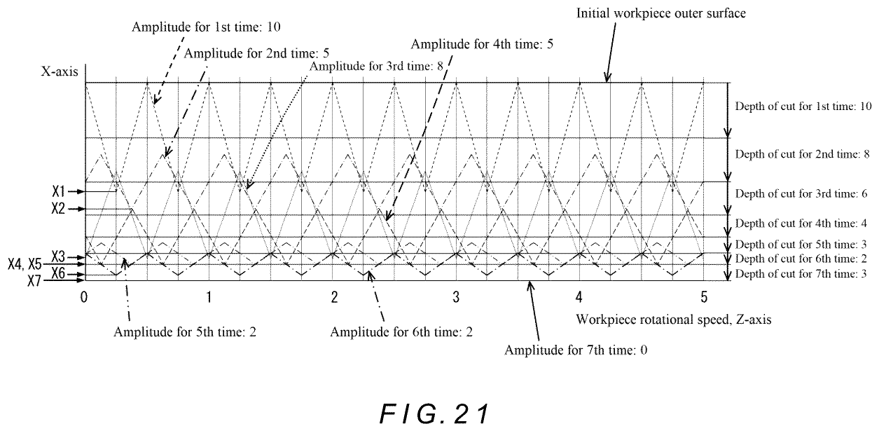

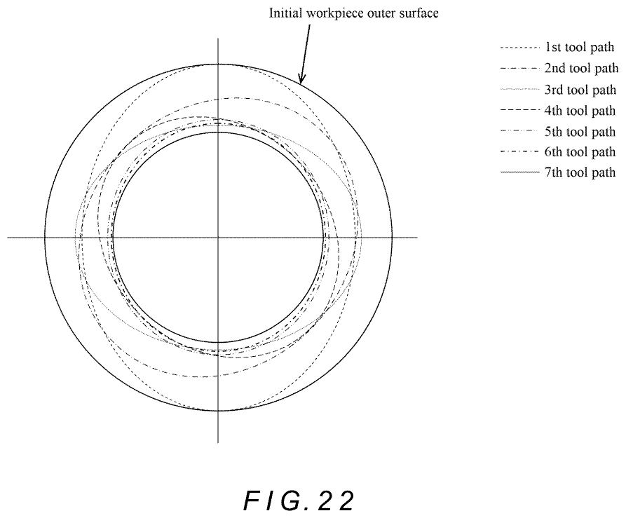

The movement paths of the cutting edge of the tool 8 (tool paths) in these thread cuttings are shown in FIGS. 21 and 22. In FIG. 21, the vertical axis represents the position of the cutting edge of the tool 108 in the X-axis direction (the radial direction), and the horizontal axis represents the position of the cutting edge of the tool 108 in the Z-axis direction (the axial direction) according to the rotation angle of the workpiece W. FIG. 22 shows the position of the cutting edge of the tool 108 in the X-axis direction (the radial direction) according to the rotation angle of the workpiece W, which corresponds to a view of the workpiece W as viewed in the axial direction thereof.

Also in this third mode, the vibration amplitude is set independently of the depth of cut in each of the first thread cutting to the seventh thread cutting. The depth of cut is set to be different for each of the first to sixth thread cuttings. The tool 108 is vibrated with different phases in the first to fifth thread cuttings. On the other hand, the tool 8 is vibrated with different amplitudes, namely, the first amplitude, the second amplitude, and the third amplitude, in the first to third thread cuttings, vibrated with the same amplitude as that in the second thread cutting, i.e., the second amplitude, in the fourth thread cutting, and vibrated with the same amplitude, i.e., the fourth amplitude, in the fifth and sixth thread cuttings.

Therefore, as shown in FIG. 21, the tool paths in the first to sixth thread cuttings are set such that two consecutive tool paths partially overlap with each other. This overlapping of the tool paths ensures breaking of chips. Further, the degree of the tool path overlapping can be set to be different for each thread cutting. Such a setting enables reduction of the cutting load while realizing breaking of chips.

In addition, since the tool 108 is not vibrated in the seventh thread cutting, the machined surface (thread groove surface) of the workpiece W machined by the tool 108 is finished with high surface accuracy.

In this first mode, the fifth and subsequent thread cuttings having no tool path overlapping are not always essential and may be omitted as appropriate.

Above have been described specific embodiments of the present invention. However, it should be noted that the present invention is not limited to the above-described embodiments and can be implemented in other manners.

For example, in the above-described embodiments, the vibration conditions for vibrating the tool 108 are stored as parameters in the parameter storage 115 and, in execution of the vibration cutting, the vibrating operation by the feed mechanism unit 107 is controlled with reference to the vibration conditions stored in the parameter storage 115. However, the present invention is not limited to such a configuration. The position of the cutting edge of the tool 108 for the vibrating operation may be sequentially specified in the NC program.

### REFERENCE SIGNS LIST

W Workpicce
1 Machine tool
2 Spindle (Workpiece holding unit)
3a Threading tool (tool)
4 Tool holding unit
10 Tool feed drive unit (feed drive unit)
11 Spindle drive unit (rotation drive unit)
23 Drive control unit (threading control unit)

What is claimed is:

1. A method of creating an NC program for threading, comprising:
a first step of setting a position in the NC program at which a G code or an M code is to be inserted;
a second step of making a setting for applying a vibration component in a thread radial direction to a tool movement path; and
a third step of, based on an instruction for reflecting the setting made in the second step in the NC program, inserting at the position in the NC program the G code or the M code for applying the vibration component in the thread radial direction, thereby creating the NC program for threading.

2. The method according to claim 1, comprising:
a fourth step of setting a tool feed rate; and
a fifth step of, after the fourth step, displaying a recommended condition or a set value on display of a workpiece rotational speed and the tool feed rate.

3. An NC program creation apparatus to be used in a machine tool, the machine tool including:
a tool holding unit holding a tool;
a workpiece holding unit holding a workpiece;
a rotation drive unit rotating the workpiece holding unit about an axis;
a feed drive unit moving the workpiece holding unit and the tool holding unit relative to each other in a direction along the axis and a direction perpendicular to the axis; and
a numerical control unit controlling the rotation drive unit and the feed drive unit in accordance with an NC program,
the NC program creation apparatus comprising:
a display unit configured to display a screen thereon;
a display control unit configured to control display of the screen on the display unit;
a data input unit configured to accept input of data through the screen displayed on the display unit; and
a program creation unit configured to create an NC program based on the data input from the data input unit, wherein:
the program creation unit is configured to create an NC program including an NC code for executing a vibration cutting operation of vibrating the tool forward and backward at a predetermined frequency in a direction perpendicular to the axis during a cutting operation of moving the tool in a direction parallel to the axis with respect to the workpiece;
the display control unit is configured to display on the display unit a selection screen for selecting one operation mode from a plurality of operation modes previously set for the vibration cutting operation;
the data input unit is configured to accept selection information about the operation mode selected on the selection screen displayed on the display unit; and
the program creation unit is configured to create an NC program including an NC code for executing a vibration cutting operation corresponding to the selection information input from the data input unit.

4. The NC program creation apparatus according to claim 3, wherein the selection screen displayed on the display unit by the display control unit is a selection screen for selecting one operation mode from the plurality of operation modes set in accordance with vibration frequency.
